(19) United States
(12) Patent Application Publication
(10) Pub. No.: US 2023/0346634 A1
(43) Pub. Date: Nov. 2, 2023

(54) MASSAGER

(71) Applicant: Guangzhou Pinai Technology Co., Ltd., Guangzhou (CN)

(72) Inventor: Yaqin WU, Guangzhou (CN)

(73) Assignee: Guangzhou Pinai Technology Co., Ltd., Guangzhou (CN)

(21) Appl. No.: 17/749,485

(22) Filed: May 20, 2022

(30) Foreign Application Priority Data
Apr. 27, 2022 (CN) 202221003186.2

(51) Int. Cl. A61H 23/00; A61H 23/06; A61H 19/00

(52) U.S. Cl. CPC A61H 23/004; A61H 23/06; A61H 19/44

(57) ABSTRACT

Disclosed is a massager, comprising an appliance body, a first massage part and a second massage part. The first massage part is connected to an end of the appliance body for massage interior of a human body; and the second massage part comprises a support, an elastic element and a first vibrating element. The support is connected to a peripheral surface of the appliance body, the elastic element is connected to the support, and the first vibrating element is connected to an end of the elastic element away from the support and located on a side of the support close to the first massage part. The technical solution of the present application can improve massage comfort of the massager.

### CROSS-REFERENCE TO RELATED APPLICATIONS

The present application claims priority to Chinese Patent Application No. 202221003186.2, filed on Apr. 27, 2022, and titled “Massager”, which is hereby incorporated for reference in its entirety for all purposes.

### TECHNICAL FIELD

The present application relates to the technical field of health care articles, in particular to a massager.

### BACKGROUND

With an acceleration of the pace of modern life and an increase of life pressure, low sexual function and sexual indifference, etc. of women are caused due to psychology, physiology, menopausal syndrome and other factors, thus the live is affected, specifically, the happiness and stability of home are affected. To solve this problem, the traditional treatment is generally drug treatment. However, drug treatment has great side effects and is harmful to health.

At present, a female health massager as a physical therapy device can play an auxiliary role in the psychology and physiology of women. The existing massager includes an appliance body, a first massage part and a second massage part, wherein the first massage part and the second massage part are connected to the appliance body, and the second massage part massages an exterior of the human body through vibration. In the existing massager, when the second massage part changes with a change of position of the first massage part, the second massage part generally cannot always maintain effective contact with the best part to be massaged, and bring less comfort. The first massage part in the existing massager has only a rotating massage device or only a vibrating massage device.

### SUMMARY

The main purpose of the present application is to provide a massager, which aims to improve the massage comfort of the massager.

In order to achieve the above purpose, the present application provides a massager, comprising:
an appliance body;
a first massage part connected to an end of the appliance body for massage interior of a human body; and
a second massage part comprising a support, an elastic element and a first vibrating element, wherein the support is connected to a peripheral surface of the appliance body, the elastic element is connected to the support, and the first vibrating element is connected to an end of the elastic element away from the support and located on a side of the support close to the first massage part.

Optionally, the elastic element is of a flat strip, and an end of the elastic element away from the support is bent towards the appliance body.

Optionally, the support and the elastic element are integrated, and an end of the support away from the appliance body is bent towards the first massage part to form an arched structure with the elastic element.

Optionally, the peripheral surface of the appliance body is provided with a mounting groove, and an end of the support away from the elastic element is mounted in the mounting groove.

Optionally, the first massage part comprises:
a rotating element mounted on the appliance body; and
a second vibrating member connected with the rotating member,
wherein the rotating element is configured for driving the second vibrating element for circular movement.

Optionally, the first massage part further comprises a first rubber sleeve sleeved on the second vibrating element and connected to the appliance body; and
wherein the second vibrating element is abutted against an inner wall surface of the first rubber sleeve to deform the first rubber sleeve when the second vibrating element is driven for circular movement by the rotating element.

Optionally, the first massage part further comprises a connecting shaft, the connecting shaft comprises a straight-line segment and a bending segment, one end of the straight-line segment is connected with the rotating element, another end of the straight-line segment is connected with an end of the bending segment, the bending segment is bent relative to the straight-line segment, and an end of the bending segment away from the straight-line segment is connected with the second vibrating element.

Optionally, the first massage part further comprises a lining mounted on the appliance body, located on a side of the rotating element, and provided with a hole, a diameter of the hole is increased along a direction away from the rotating element, the lining is sleeved on the bending segment and the bending segment is extended to pass through the hole, the bending segment is configured to make circular movement around an axis of the hole in the gradually expanding hole.

Optionally, the second massage part further comprises a second rubber sleeve sleeved on the first vibrating element, the elastic element and the support.

Optionally, the appliance body is provided with a battery and a main board electrically connected with the battery;
an outer surface of the appliance body is provided with a key electrically connected with the main board; and
the first vibrating element and the first massage part are electrically connected to the main board.

The massager of the technical solution of the present application comprises an appliance body, a first massage part and a second massage part. The first massage part is connected to an end of the appliance body for endosomatic massage. The second massage part includes a support, an elastic element and a first vibrating element. The support is connected to a peripheral surface of the appliance body and the elastic element is connected to the support. The first vibrating element is connected to an end of the elastic element away from the support and located on a side of the support close to the first massage part. Therefore, when the first massage part enters the endosomatic for massage, the first vibrating element can massage the exterior of the human body at the same time, and attach tightly to the exterior of the human body by the elastic force of the elastic element, so that the first vibrating element will not be rigidly abutted against the exterior of the human body, and when the position of the first massage part changes, the second massage part can always effectively contact the best part to be massaged, so as to improve the massage comfort of the massager.

### BRIEF DESCRIPTION OF THE DRAWINGS

In order to more clearly explain the embodiment of the present application or the technical solution in the related art, the following will briefly introduce the attached drawings in the embodiment or the description of the related art. It is obvious that the attached drawings in the following description are only some embodiments of the present application. For those skilled in the art, without paying creative labor, other drawings can also be obtained according to the structure shown in these drawings.

FIG. 1 is an isometric view of an embodiment of a massager of the present application.

FIG. 2 is an exploded view of the massager of the present application.

FIG. 3 is a sectional view of the massager of the present application.

FIG. 4 is an enlarged view of portion A of FIG. 3.

The realization of the purpose, functional features and advantages of the present application will be further described with reference to the attached drawings in combination with the embodiments.

### DETAILED DESCRIPTION OF THE EMBODIMENTS

The technical solution in the embodiment of the present application will be clearly and completely described below in combination with the attached drawings in the embodiment of the present application. Obviously, the described embodiments are only part of the embodiments of the present application, not all of the embodiments. Based on the embodiments of the present application, all other embodiments obtained by those skilled in the art without creative work belong to the claimed scope of the present application.

It should be noted that in the embodiment of the present application, all directional indications (such as up, down, left, right, front, back . . . ) are only used to explain the relative position relationship and movement among components under a specific attitude (as shown in the attached figure). If the specific attitude changes, the directional indications will change accordingly.

In addition, the description of “first”, “second” and the like in the present application is only for the purpose of description, and cannot be understood as indicating or implying its relative importance or implicitly indicating the number of indicated technical features. Thus, the features defined with “first” and “second” may include at least one of the features explicitly or implicitly. In addition, the technical solutions of various embodiments can be combined with each other, but it must be based on the realization of those skilled in the art. When the combination of technical solutions is contradictory or impossible, it should be considered that the combination of technical solutions does not exist and is not within the claimed scope required by the present application.

The present application provides a massager.

As shown in FIGS. 1 to 3, in an embodiment of the present application, the massager 100 includes an appliance body 10, a first massage part 30 and a second massage part 50. The first massage part 30 is connected to an end of the appliance body 10 for massaging an interior of a human body. The second massage part 50 includes a support 51, an elastic element 53 and a first vibrating element 55. The support 51 is connected to a peripheral surface of the appliance body 10, the elastic element 53 is connected to the support 51, and the first vibrating element 55 is connected to an end of the elastic element 53 away from the support 51 and located on a side of the support 51 close to the first massage part 30.

In this embodiment, the massager 100 includes an appliance body 10, a first massage part 30 and a second massage part 50. The first massage part 30 is connected to an end of the appliance body 10 for massaging the interior of the human body. The second massage part 50 includes a support 51, an elastic element 53 and a first vibrating element 55. The support 51 is connected to the peripheral surface of the appliance body 10 and the elastic element 53 is connected to the support 51. The first vibrating element 55 is connected to an end of the elastic element 53 away from the support 51 and located on the side of the support 51 close to the first massage part 30. Therefore, when the first massage part 30 enters the body for massage, the first vibrating element 55 can massage the exterior of the human body at the same time, and the first vibrating element 55 can attach tightly to the exterior of the human body by the elastic force of the elastic element 53, thus, the first vibrating element 55 is not be rigidly abutted against the exterior of the human body, when the position of the first massage part 30 changes, the second massage part 50 can always effectively contact the best part for massage, so as to improve the massage comfort of using the massager 100, and have an auxiliary treatment effect on the psychology or physiology of the user. In addition, compared with using a complex hinge structure to realize the movement of the first vibrating element 55, the massage of the present application has the advantages of simple and reliable structure, easy being manufactured and processed, improved production efficiency and reduced production cost.

The first massage part 30 can perform vibration massage by a vibrating motor, or rotation massage by a rotating motor, or both vibration massage by the vibrating motor and rotation massage by the rotating motor, or massage in other ways.

The first vibrating member 55 may be a vibrating motor, a linear motor, or another effective vibrating member.

The elastic member 53 may be an elastic strip, a spring, or another effective elastic member 53.

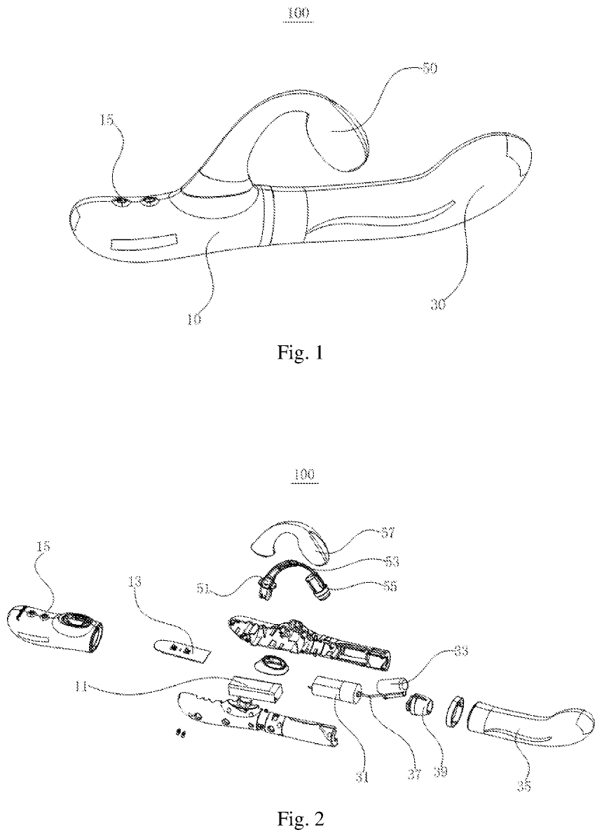

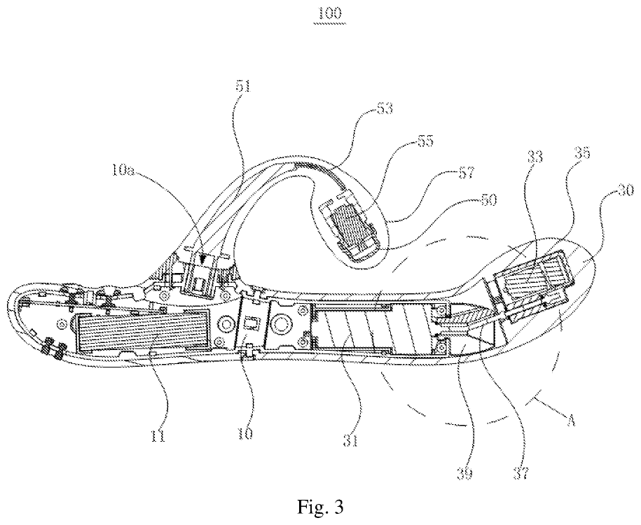

As shown in FIG. 2 and FIG. 3, in an embodiment of the present application, the elastic member 53 is of flat strip, and an end of the elastic member 53 away from the support 51 is bent towards the appliance body 10.

In this embodiment, the elastic member 53 is of flat strip. It can be understood that the elastic member 53 is of thin strip. The elastic member 53 has two opposite ends in a length direction thereof, one end of the elastic member 53 is connected to the support 51, and the other end of the elastic member 53 is connected to the vibrating member. The end of the elastic member 53 away from the support 51 is bent towards the appliance body 10. It can be understood that the elastic member 53 is arched with a certain radian, and the whole elastic member 53 is arched and bent towards the appliance body 10, so that when the two ends of the elastic member 53 are close to or away from each other, the elastic member 53 will produce an elastic force, thus, when the first vibrating member 55 is close to or away from the support 51 by an external force, the elastic member 53 can produce an elastic force against the external force, as a result, the first vibrating member 55 can attach tightly to the exterior of the human body by the elastic force of the elastic member 53, the first vibrating member 55 is not rigidly contact the exterior of the human body, the massage comfort brought by the massager 100 is improved. With this arrangement, the elastic member 53 is simple and reliable, easy to be manufactured and cost saving.

As shown in FIG. 2 and FIG. 3, in an embodiment of the present application, the support 51 and the elastic member 53 are integrated, and an end of the support 51 away from the appliance body 10 is bent towards the first massage part 30 to form an arched structure with the elastic member 53.

In this embodiment, the support 51 is fixedly connected to the appliance body 10, and the support 51 and the elastic member 53 are integrated, that is, the support 51 and the elastic member 53 are integrally formed or molded. The support 51 and the elastic member 53 form an arched structure. It can be understood that the end of the support 51 away from the appliance body 10 is thinner to be elastic, and the end of the support 51 away from the appliance body 10 is bent toward the appliance body to form a bow shape, so as to further improve the elasticity. This arrangement can not only ensure that the elastic element 53 has certain elasticity, but also reduce the bending of the elastic element 53, so as to reduce the toughness requirements to the elastic element 53 and facilitate the production of the elastic element 53. Moreover, the processing of the support 51 and the elastic element 53 are also facilitated, the process of the support 51 and the elastic element 53 is simplified, and the production efficiency is improved and the cost is saved.

Specifically, the support 51 and the elastic member 53 are made of plastic to facilitate integrated manufacturing and molding. The elastic member 53 can be a long, flat strip, and bent towards the appliance body 10, so that the elastic member 53 can be bent to a certain extent for produce the elastic force.

As shown in FIG. 2 and FIG. 3, in an embodiment of the present application, a peripheral surface of the appliance body 10 is provided with a mounting groove 10a, and an end of the support 51 away from the elastic member 53 is mounted in the mounting groove 10a.

In this embodiment, the peripheral surface of the appliance body 10 is provided with a mounting groove 10a, and the end of the support 51 is fixedly connected in the mounting groove 10a with a fixed connection such as a clamping connection, a screw connection, or another effective fixed connection method. This arrangement simplifies the assembly of the appliance body 10 and the support 51 and improves the assembly efficiency. Moreover, since the second massage part 50 will be subjected to the force in the length direction of the appliance body 10 when massaging the exterior of the body. The mounting groove 10a can effectively limit the support 51, and a groove wall of the mounting groove 10a can abut against the support 51 in the direction of the force, making the whole massager 100 more durable.

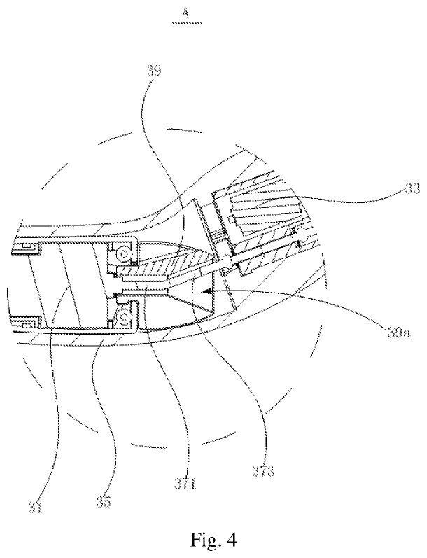

As shown in FIG. 2, FIG. 3 and FIG. 4, in an embodiment of the present application, the first massage part 30 includes a rotating element 31 and a second vibrating element 33. The rotating element 31 is mounted on the appliance body 10, the second vibrating member 33 is connected with the rotating member 31. The rotating member 31 drives the second vibrating member 33 for circular movement.

In this embodiment, the rotating element 31 is fixedly connected with the appliance body 10 with a fixed connection such as a clamping fixed connection, a screw fixed connection, or another effective fixed connection method. The second vibrating member 33 is in transmission connection with the rotating member 31, the transmission connection can be a rotating shaft connection, a planetary gear connection, or another effective transmission connection mode. The rotating member 31 drives the second vibrating member 33 for circular movement. It can be understood that the rotating member 31 drives the second vibrating member 33 for circular movement around a rotation axis of the rotating member 31. In this way, the movement range of the second vibrating element 33 can be expanded, so as to expand the massage range and improve the comfort. The rotating element 31 cooperates with the second vibrating element 33 to realize both the rotation massage and vibration massage at the same part of the human body at the same time, thereby improving the massage effect.

In addition, it should be noted that the rotating element 31 can be a direct-current (DC) rotating motor, an alternative-current (AC) rotating motor, or another effective rotating element 31.

The second vibrating element 33 may be a vibrating motor, a linear motor, or another effective vibrating element.

As shown in FIG. 2 and FIG. 3, in an embodiment of the present application, the first massage part 30 also includes a first rubber sleeve 35 sleeved on the second vibrating element 33 and connected to the appliance body 10. When the rotating member 31 drives the second vibrating member 33 for circular movement, the second vibrating member 33 is abutted against an inner wall surface of the first rubber sleeve to deform the first rubber sleeve 35.

In this embodiment, the first soft rubber sleeve 35 is soft and elastic, which can improve the massage comfort brought by the second massage part 50. In addition, the first soft rubber sleeve 35 can protect the first vibrating element 55, the elastic element 53 and the support 51 to prolong the service life of the massager 100.

In addition, it should be noted that the first soft rubber sleeve 35 can be a silicone sleeve, a rubber sleeve or a sleeve of other materials.

As shown in FIG. 2, FIG. 3 and FIG. 4, in an embodiment of the present application, the first massage part 30 also includes a connecting shaft 37, the connecting shaft 37 includes a straight-line segment 371 and a bending segment 373, one end of the straight-line segment 371 is connected with the rotating member 31, the other end of the straight-line segment 371 is connected with one end of the bending segment 373, the bending segment 373 is bent relative to the straight-line segment 371, and an end of the bending segment 373 away from the straight-line segment 371 is connected with the second vibrating member 33.

In this embodiment, the bending segment 373 is bent relative to the straight-line segment 371. It can be understood that the bending segment 373 and the straight-line segment 371 are not on the same line, that is, the straight-line segment 371 is coaxial with the rotating shaft of the rotating element 31, while the bending segment 373 is bent relative to the straight-line segment 371, so that when the straight-line segment 371 is driven to rotate by the rotating element 31, the bending segment 373 will swing to make the second vibrating element 33 move around the axis, so as to expand the movement range of the second vibrating element 33, and the massage range is further expanded to improve the treatment effect.

As shown in FIG. 2, FIG. 3 and FIG. 4, in an embodiment of the present application, the first massage part 30 also includes a lining 39 mounted on the appliance body 10 and located on a side of the rotating element 31, the lining 39 is funnel-shaped and provided with a hole 39a whose diameter is increased along a direction away from the rotating element 31, and the lining 39 is sleeved on the bending segment 373 and the bending segment 373 is extended through the hole 39a, and makes circular movement around an axis of the hole 39a.

Since the second vibrating member 33 and the rotating member 31 are driven by the connecting shaft 37, the connecting shaft 37 will be subjected to a large force. However, because the arrangement of the hole 39a, the hole 39a can support two ends of the connecting shaft 37, so as to change the situation that two ends of the connecting shaft 37 is subjected to a force to the situation that the connecting shaft 37 is subjected to a force in a length direction thereof, which can reduce the mechanical fatigue of the connecting shaft 37, prevent the connecting shaft 37 from breaking, and improve the service life of the connecting shaft 37. The lining 39 can also guide the circular movement of the bending segment 373 of the connecting shaft 37, and provide sufficient movement space for the bending segment 373 of the connecting shaft 37 and protect the connecting shaft 37.

As shown in FIG. 2 and FIG. 3, in an embodiment of the present application, the second massage part 50 also includes a second soft rubber sleeve 57 sleeved on the first vibrating element 55, the elastic element 53 and the support 51.

In this embodiment, the first massage part 30 also includes a second soft rubber sleeve 57 sleeved in the second vibrating member 33, and connected to the appliance body 10. When the rotating member 31 drives the second vibrating member 33 for circular movement, the second vibrating member 33 is abutted against an inner wall surface of the second rubber sleeve 57 to deform the second rubber sleeve 57. It can be understood that an end of the second rubber sleeve 57 is fixedly connected to the appliance body 10, and the second rubber sleeve 57 is not rotated. Because an inner of an end of the second rubber sleeve 57 away from the appliance body 10 is affected by the circular movement of the second vibrating element 33, the second rubber sleeve 57 is deformed, so that the end of the second rubber sleeve 57 away from the appliance body 10 also makes a circular movement. Thus, during the rotation massage, since the second rubber sleeve 57 as a whole does not rotate, the human body can be protected during the massage and the comfort of the massage can be improved.

Further, the second rubber sleeve 57 is made of food grade rubber with good elasticity. The first vibrating element 55, the elastic element 53 and the support 51 are coated with the food grade rubber with good elasticity. It can be understood that when the first vibrating element 55 contacts the exterior of the body to be massaged, the second rubber sleeve 57 can provide an elastic force to the first vibrating element 55 to make the second massage part 50 to attach tightly to the best part to be massaged with a change of the position of the first massage part 30. Specifically, when the first vibrating element 55 contacts the exterior of the body to be massaged, the elastic element 53 and the second rubber sleeve 57 will produce elastic forces. Therefore, when the first vibrating element 55 moves close to or away from the support 51 by the external force, the elastic element 53 and the second rubber sleeve 57 can produce elastic forces against the external force, such that the first vibrating member 55 can attach tightly to the exterior of the human body by the elastic forces of the elastic member 53 and the second rubber sleeve 57. The food grade rubber has the characteristics of non-toxic and harmless, such as natural rubber. Food grade rubber already exists in the prior art, so detail thereof will not be repeated here.

In addition, it should be noted that the second rubber sleeve 57 can be a silicone sleeve, a rubber sleeve or a sleeve of another material.

As shown in FIGS. 1 to 3, in an embodiment of the present application, the appliance body 10 is provided with a battery 11 and a main board 13 electrically connected with the battery 11. An outer surface of the appliance body 10 is also provided with a key 15 electrically connected with the main board 13. The first vibrating element 55 and the first massage part 30 are electrically connected to the main board 13.

In this embodiment, the battery 11 is connected to the main board 13 through wires, the battery 11 is mounted inside the appliance body 10, the main board 13 is also mounted inside the appliance body 10, and the outer surface of the appliance body 10 is also provided with a key 15 connected with the main board 13 through wires. The first vibrating member 55 is connected to the main board 13 through wires, the second vibrating member 33 is also connected to the main board 13 through wires, and the battery 11 provides power to the first vibrating member 55 and the second vibrating member 33 through the main board 13. The key 15 controls the first vibrating member 55 and the second vibrating member 33 through the main board 13. Specifically, a plurality of keys 15 can be provided, and the plurality of keys can be configured to control the power on or off of the first vibrating member 55, the power on or off of the second vibrating member 33, the vibration intensity of the first vibrating member 55, the vibration intensity of the second vibrating member 33, etc. In this way, the portability of the massager 100 can be improved, the operation and control of the massager 100 can be facilitated, and the user experience can be improved. Of course, in order to further improve the convenience of the massager 100, a rechargeable battery 11 can be adopted, and a magnetic suction charging needle is provided on the outer surface of the appliance body 10. The magnetic suction charging needle is electrically connected with the rechargeable battery 11, so that the magnetic suction charging needle can be quickly connected to the charger, and the rechargeable battery 11 can be recharged, thereby improving the convenience of the massager 100.

As shown in FIGS. 1 to 3, the massager 100 includes an appliance body 10, a first massage part 30 and a second massage part 50. The first massage part 30 is connected to the end of the appliance body 10 for massage the interior of the human body and has the functions of rotation massage and vibration massage. The second massage part 50 includes a support 51, an elastic element 53 and a first vibrating element 55. The support 51 is connected to the peripheral surface of the appliance body 10, the elastic element 53 is connected to the support 51, the first vibrating element 55 is connected to an end of the elastic element 53 away from the support 51 and located on a side of the support 51 close to the first massage part 30 and has the function of vibration massage. The present application can improve the massage comfort of the massager 100.

The above is only the preferred embodiment of the present application and does not limit the scope of the patent of the present application. Under the inventive concept of the present application, any equivalent structural transformation made by using the contents of the description and drawings of the present application, or any direct/indirect application in other relevant technical fields, is included in the claimed scope of the present application.

1. A massager, comprising:
an appliance body;
a first massage part connected to an end of the appliance body for massage interior of a human body; and
a second massage part comprising a support, an elastic element and a first vibrating element, wherein the support is connected to a peripheral surface of the appliance body, the elastic element is connected to the support, and the first vibrating element is connected to an end of the elastic element away from the support and located on a side of the support close to the first massage part.

2. The massager according to claim 1, wherein the elastic element is a flat strip, and an end of the elastic element away from the support is bent towards the appliance body.

3. The massager according to claim 2, wherein the support and the elastic element are integrated, and an end of the support away from the appliance body is bent towards the first massage part to form an arched structure with the elastic element.

4. The massager according to claim 3, wherein the peripheral surface of the appliance body is provided with a mounting groove, and an end of the support away from the elastic element is mounted in the mounting groove.

5. The massager according to claim 1, wherein the first massage part comprises:
a rotating element mounted on the appliance body; and
a second vibrating member connected with the rotating member,
wherein the rotating element is configured for driving the second vibrating element for circular movement.

6. The massager according to claim 5, wherein the first massage part further comprises a first rubber sleeve sleeved on the second vibrating element and connected to the appliance body; and
wherein the second vibrating element is abutted against an inner wall surface of the first rubber sleeve to deform the first rubber sleeve when the second vibrating element is driven for circular movement by the rotating element.

7. The massager according to claim 6, wherein the first massage part further comprises a connecting shaft, the connecting shaft comprises a straight-line segment and a bending segment, one end of the straight-line segment is connected with the rotating element, another end of the straight-line segment is connected with an end of the bending segment, the bending segment is bent relative to the straight-line segment, and an end of the bending segment away from the straight-line segment is connected with the second vibrating element.

8. The massager according to claim 7, wherein the first massage part further comprises a lining mounted on the appliance body, located on a side of the rotating element, and provided with a hole, a diameter of the hole is increased along a direction away from the rotating element, the lining is sleeved on the bending segment and the bending segment is extended to pass through the hole, the bending segment is configured to make circular movement around an axis of the hole in the gradually expanding hole.

9. The massager according to claim 1, wherein the second massage part further comprises a second rubber sleeve sleeved on the first vibrating element, the elastic element and the support.

10. The massager according to claim 1, wherein the appliance body is provided with a battery and a main board electrically connected with the battery;
an outer surface of the appliance body is provided with a key electrically connected with the main board; and
the first vibrating element and the first massage part are electrically connected to the main board.
